(19) United States
(12) Patent Application Publication
(10) Pub. No.: US 2020/0410371 A1
(43) Pub. Date: Dec. 31, 2020

(54) DATA ANALYSIS METHOD AND DEVICE

(71) Applicant: Baidu Online Network Technology (Beijing) Co., Ltd., Beijing (CN)

(72) Inventors: Chaoyang CHEN, Beijing (CN); Mengmeng ZHANG, Beijing (CN); Wenming WANG, Beijing (CN)

(21) Appl. No.: 16/688,306

(22) Filed: Nov. 19, 2019

(30) Foreign Application Priority Data
Jun. 28, 2019 (CN) 201910583534.4

(51) Int. Cl. G06N 5/04

(52) U.S. Cl. CPC G06N 5/04

(57) ABSTRACT

A data analysis method and device are provided. The method includes: acquiring historical behavior data of a user, wherein the historical behavior data includes information on a historical time period and a historical behavior in the historical time period; selecting first historical behavior data meeting a first preset condition from the historical behavior data of the user; and determining a habit of the user based on the first historical behavior data meeting the first preset condition. Historical behavior data may be analyzed to obtain a habit of a user, thereby improving an intelligence degree of a system.

### RELATED APPLICATION

The present application claims priority to Chinese Application No. 201910583534.4 filed Jun. 28, 2019, which is hereby incorporated herein in its entirety by reference.

### TECHNICAL FIELD

The present application relates to a field of information processing technology, and in particular, to a data analysis method and device.

### BACKGROUND

At present, when a user plays content, a server may acquire playing data of the user and store the playing data thereon. However, there is still no scheme for how to use the playing data of a user in a subsequent process. In addition, processing processes are still simple, and mainly provide content to a user according to a request of the user. The degree of intelligence of such systems can be improved.

### SUMMARY

A data analysis method and device are provided according to embodiments of the present application, so as to at least solve the above technical problems in the existing technology.

In a first aspect, a data analysis method is provided according to an embodiment of the present application. The method includes: acquiring historical behavior data of a user, wherein the historical behavior data includes information on a historical time period and a historical behavior in the historical time period, selecting first historical behavior data meeting a first preset condition from the historical behavior data of the user, and determining a habit of the user based on the first historical behavior data meeting the first preset condition.

In an implementation, the first preset condition may include an occurrence frequency of the first historical behavior during a first historical time period in a preset time period reaching a preset frequency threshold.

In an implementation, information on the first historical behavior may include at least one of: a label of the first historical behavior and a category of the first historical behavior.

In an implementation, the method further includes providing a recommendation for the user based on the determined habit of the user.

In a second aspect, a data analysis device is provided according to an embodiment of the present application. The device includes: a data acquisition unit configured to acquire historical behavior data of a user, wherein the historical behavior data includes information on a historical time period and a historical behavior in the historical time period; and a habit analysis unit configured to select first historical behavior data meeting a first preset condition from the historical behavior data of the user, and determine a habit of the user based on the first historical behavior data meeting the first preset condition.

In an implementation, the first preset condition includes: an occurrence frequency of the first historical behavior during a first historical time period in a preset time period reaching a preset frequency threshold.

In an implementation, information on the first historical behavior includes at least one of: a label of the first historical behavior and a category of the first historical behavior.

In an implementation, the device further includes: a processing unit configured to provide a recommendation for the user based on the determined habit of the user.

In a third aspect, a data analysis device is provided according to an embodiment of the present application. The functions of the device may be implemented by using hardware or by corresponding software executed by hardware. The hardware or software includes one or more modules corresponding to the functions described above.

In a possible embodiment, the device structurally includes a processor and a memory, wherein the memory is configured to store a program which supports the data analysis device in executing the above data analysis method. The processor is configured to execute the program stored in the memory. The device may further include a communication interface through which the device communicates with other devices or communication networks.

In a fourth aspect, a computer-readable storage medium for storing computer software instructions used for a data analysis device is provided. The computer readable storage medium may include programs involved in executing of the data analysis method described above.

Each of the above technical solutions may have the following advantages or beneficial effects: a habit of a user may be obtained by analyzing historical behavior data of the user. In this way, historical behavior data may be analyzed to obtain a habit of a user, thereby improving the intelligence degree of a system. In addition, after a habit of a user is determined, the user may be provided with recommendations and other services with a higher quality, thereby making the service provided to the user more personalized and improving user experience.

The above summary is provided only for illustration and is not intended to be limiting in any way. In addition to the illustrative aspects, embodiments, and features described above, further aspects, embodiments, and features of the present application will be readily understood from the following detailed description with reference to the accompanying drawings.

### BRIEF DESCRIPTION OF THE DRAWINGS

In the drawings, unless otherwise specified, identical or similar parts or elements are denoted by identical reference numerals throughout the drawings. The drawings are not necessarily drawn to scale. It should be understood these drawings merely illustrate some embodiments of the present application and should not be construed as limiting the scope of the present application.

FIG. 1 is a flow chart showing a data analysis method according to an embodiment of the present application;

FIG. 2 is a schematic structure block diagram I showing a data analysis device according to an embodiment of the present application; and

FIG. 3 is a schematic structure block diagram II showing a data analysis device according to an embodiment of the present application.

### DETAILED DESCRIPTION OF THE EMBODIMENTS

Hereafter, only certain exemplary embodiments are briefly described. As can be appreciated by those skilled in the art, the described embodiments may be modified in different ways without departing from the spirit or scope of the present application. Accordingly, the drawings and the description should be considered as illustrative in nature instead of being restrictive.

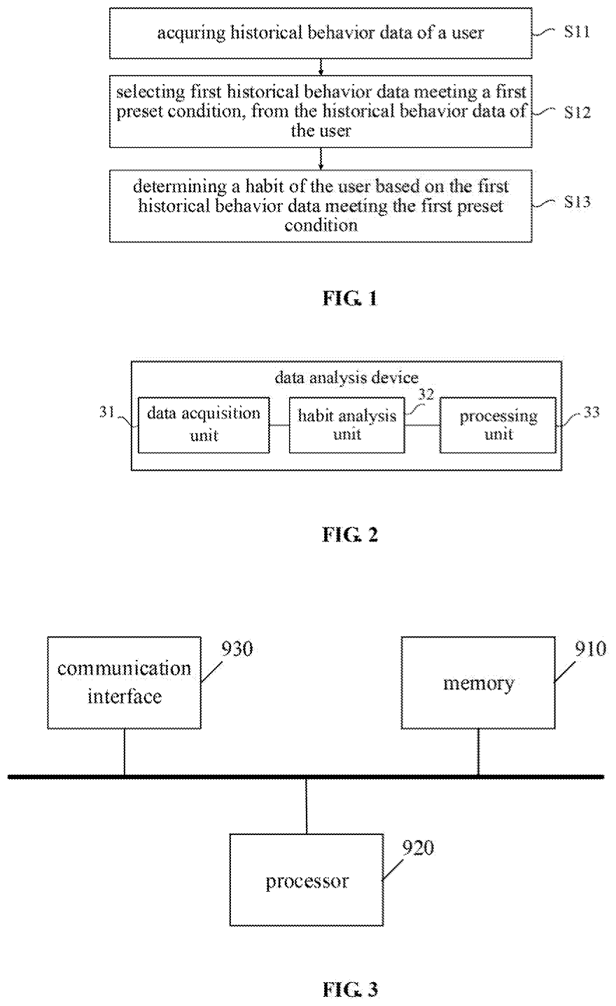

In an implementation, FIG. 1 is a flowchart showing a data analysis method according to an embodiment of the present application. At S11, historical behavior data of a user is acquired, where the historical behavior data includes information on a historical time period and a historical behavior in the historical time period.

At S12, first historical behavior data meeting a first preset condition is selected from the historical behavior data of the user.

At S13, a habit of the user is determined based on the first historical behavior data meeting the first preset condition.

Here, a scheme according to embodiments of the present application may be applied to an apparatus having a processing function. For example, the scheme may be applied to a server on a network side.

The aforementioned acquiring historical behavior data of a user may be understood as acquiring historical behavior data of the user within a certain time period. For example, historical behavior data of a user within 15 days may be acquired.

It should also be understood that when the server analyzes historical behavior data of a user, historical behavior data of multiple users currently managed may be acquired. Then, the aforementioned processing may be performed for each of the users. Finally, habits of multiple users or at least some users currently managed may be determined by using the aforementioned scheme.

It should be pointed out that in addition to information on a historical time period and a historical behavior in the historical time period, the historical behavior data may further include a user identifier, such as a CUID. That is to say, the user identifier may be used to identify the user associated with the historical behavior data. In this way, when related recommendation information is determined based on a habit of a user in a subsequent process, a correspondence among data, information, and a user can be determined.

The first preset condition may include: an occurrence frequency of the first historical behavior during a first historical time period in a preset time period reaching a preset frequency threshold.

The preset time period may be set according to actual situations. For example, according to certain actual situations, the preset time period may be set to 1 month or 7 days.

It should be pointed out that the first historical time period may refer to different first historical time periods within different days. For example, the first historical time period may be a time period from 7 pm to 9 pm on each day within 30 days.

The frequency of playing historical content may be determined by calculation based on a number of plays/a preset time period. For example, within 8 days, a user played a song by a particular artist for 15 times in a same time period on each day. For another example, within 8 days, a user played jazz for 7 times in another time period on each day.

The preset frequency threshold may be set according to actual situations. For example, the current highest frequency may be set as the preset frequency threshold. Alternatively, a value may be set as the preset frequency threshold.

In the case where a current highest frequency is set as the preset frequency threshold, the historical behavior data with the highest playing frequency may be selected as first historical behavior data.

In the case where a value is set as the preset frequency threshold, it may be understood as that historical behavior data having playing frequencies higher than the value are selected as multiple first historical behavior data.

Information on the first historical behavior may include at least one of: a label of the first historical behavior and a category of the first historical behavior.

Determining a habit of at least one of the users based on the first historical behavior data meeting the first preset condition may include setting the first historical time period related to the first historical behavior data and the label (or the category) of the historical behavior as a habit of the user.

For example, see Table 1:

TABLE 1

| | Category of | Label of | | Times |
|---|---|---|---|---|
| Time | Historical | Historical | Active | Of |
| Period | Behavior | Behavior | Day | Requests |
| 6pm-8pm | music | playing a song | 8 | 19 |
| | | of a singer A | | |
| 8 pm-10 pm | music | playing music | 10 | 2 |
| 10 pm-12 pm | music | playing rock | 12 | 9 |
| | | and roll | | |

In Table 1, the time period from 6 pm to 8 pm may be considered as a first historical time period. The playing a song of a singer A may be considered as the information on a first historical behavior, and further, these two contents may be considered as a habit of a user.

It should be pointed out that setting such information as a habit of a user may include setting a flag for the user on a server side. For example, it may be firstly set that the user has the habit, and then the content of the habit of the user may be set.

In embodiments of the present application, a historical behavior may include behaviors that result from user interactions. For example, a historical behavior may include requesting to play content type information. A historical behavior may also include a query behavior, such as a stock query. In this case, the content obtained by the user may not be voice content, but related content displayed to the user via a screen. Further, a historical behavior may include a direct playing behavior, such as ringing of an alarm clock. Similar examples are not listed here repeatedly.

Further, based on aforementioned schemes, according to embodiments of the present application, a recommendation may be provided for a user based on a determined habit of the user.

For example, a recommendation related to a habit may be provided to a user. The providing a recommendation related to a habit to a user may include: generating a recommendation request and providing the recommendation request to the user, where the recommendation request may be used to request the user to constantly play first historical playing content in a first time period. In the case where an affirmative feedback is received from the user, the habit may be set as a routine behavior of the user. In the case where a rejection feedback is received from the user, information related to the habit may no longer be recommended to the user.

It should also be understood that according to the scheme in embodiments of the present application, one habit or multiple habits may be generated for a user. The number of habits that are generated for a user may depend on a preset rule. For example, a rule may be preset as: for user, one habit may be generated within a certain time period. Alternatively, a rule may be preset as: for a user, at most two habits may be generated within a certain time period.

Furthermore, according to embodiments of the present application, historical behavior data of users that may be collected on the entire network are analyzed. Thus, a final result may be that multiple users have a same habit. In this case, the habit may be used to characterize the group of users. The final result may also be that another group of users have another identical habit. In this case, the other identical habit may be used to characterize the other group of users. Similar examples are not listed here repeated.

It can be seen that according to above scheme, a habit of a user may be obtained by analyzing historical behavior data of the user. In this way, historical behavior data may be analyzed to obtain a habit of a user, thereby improving intelligence degree of a system. In addition, after a habit of a user is determined, the user may be provided with recommendations and other services with a higher quality, thereby making the service provided to the user more personalized and improving user experience.

In an implementation, FIG. 2 shows a data analysis device according to an embodiment of the present application. The device includes: a data acquisition unit 31, configured to acquire historical behavior data of a user, wherein the historical behavior data includes information on a historical time period and a historical behavior in the historical time period; and a habit analysis unit 32, configured to select first historical behavior data meeting a first preset condition, from the historical behavior data of the user, and determine a habit of the user based on the first historical behavior data meeting the first preset condition.

Here, the scheme according to embodiments of the present application may be applied to an apparatus having a processing function. For example, the scheme may be applied to a server on a network side.

The aforementioned acquiring historical behavior data of a user may be understood as acquiring historical behavior data of the user within a certain time period. For example, historical behavior data of a user within 15 days may be acquired.

It should be further understood that when analyzing historical behavior data of a user on a server side, historical behavior data of multiple users currently managed may be acquired. Then, the aforementioned processing may be performed for each of the multiple users. Finally, habits of the multiple users or at least some users currently managed may be determined by using the aforementioned scheme.

It should be pointed out that in addition to information on a historical time period and a historical behavior in the historical time period, the historical behavior data may further include a user identifier, such as a CUID. That is to say, by using the user identifier, it is possible to determine with which user the historical behavior data is associated. In this way, when related recommendation information is determined based on a habit of a user in a subsequent process, data, information, and a user can be correctly correlated with each other.

The first preset condition includes: an occurrence frequency of the first historical behavior during a first historical time period in a preset time period reaching a preset frequency threshold.

The preset time period may be set according to actual situations. For example, according to certain actual situations, the preset time period may be set to 1 month or 7 days.

It should be pointed out that the first historical time period may refer to different first historical time periods within different days. For example, the first historical time period may be a time period from 7 pm to 9 pm on each day within 30 days.

The frequency of playing historical content may be determined by calculation based on a number of plays/a preset time period. For example, within 8 days, a user played a song of Jay Chou for 15 times in a same time period on each day. For another example, within 8 days, a user played jazz for 7 times in another time period on each day.

The preset frequency threshold may be set according to actual situations. For example, the current highest frequency may be set as the preset frequency threshold. Alternatively, a value may be set as the preset frequency threshold.

In the case where a current highest frequency is set as the preset frequency threshold, the historical behavior data with the highest playing frequency may be selected as first historical behavior data.

In the case where a value is set as the preset frequency threshold, it may be understood as that historical behavior data having playing frequencies higher than the value are selected as multiple first historical behavior data.

Information on the first historical behavior may include at least one of: a label of the first historical behavior and a category of the first historical behavior.

The determining a habit of at least one of the users based on the first historical behavior data meeting the first preset condition may include setting the first historical time period related to the first historical behavior data and the label (or the category) of the historical behavior as a habit of the user.

It should be pointed out that setting such information as a habit of a user may include setting a flag for the user on a server side. For example, it may be firstly set that the user has the habit, and then the content of the habit of the user may be set.

Further, based on aforementioned schemes, the device provided in embodiments of the present application may further include: a processing unit 33 configured to provide a recommendation for the user based on the determined habit of the user.

For example, a recommendation related to a habit may be provided to a user. The providing a recommendation related to a habit to a user may include generating a recommendation request and providing the recommendation request to the user, where the recommendation request may be used to request the user to constantly play first historical playing content in a first time period. In the case where an affirmative feedback is received from the user, the habit may be set as a routine behavior of the user. In the case where a rejection feedback is received from the user, information related to the habit may no longer be recommended to the user.

It should also be understood that according to the scheme in embodiments of the present application, one habit or multiple habits may be generated for a user. The number of habits that are generated for a user may depend on a preset rule. For example, a rule may be preset as: for user, one habit may be generated within a certain time period. Alternatively, a rule may be preset as: for a user, at most two habits may be generated within a certain time period.

Furthermore, according to embodiments of the present application, historical behavior data of users that may be collected on the entire network are analyzed. Thus, a final result may be that multiple users have a same habit. In this case, the habit may be used to characterize the group of users. The final result may also be that another group of users have another identical habit. In this case, the other identical habit may be used to characterize the other group of users. Similar examples are not listed here repeated.

It can be seen that according to above scheme, a habit of a user may be obtained by analyzing historical behavior data of the user. In this way, historical behavior data may be analyzed to obtain a habit of a user, thereby improving intelligence degree of a system. In addition, after a habit of a user is determined, the user may be provided with recommendations and other services with a higher quality, thereby making the service provided to the user more personalized and improving user experience.

FIG. 3 is a schematic structure block diagram showing a data analysis device according to an embodiment of the present application. As shown in FIG. 3, the device includes a memory 910 and a processor 920, wherein a computer program that can run on the processor 920 is stored in the memory 910. The processor 920 executes the computer program to implement the method according to foregoing embodiments. The number of either the memory 910 or the processor 920 may be one or more.

The device may further include a communication interface 930 configured to communicate with an external device and exchange data.

The memory 910 may include a high-speed RAM memory and may also include a non-volatile memory, such as at least one magnetic disk memory.

If the memory 910, the processor 920, and the communication interface 930 are implemented independently, the memory 910, the processor 920, and the communication interface 930 may be connected to each other via a bus to realize mutual communication. The bus may be an Industry Standard Architecture (ISA) bus, a Peripheral Component Interconnected (PCI) bus, an Extended Industry Standard Architecture (EISA) bus, or the like. The bus may be categorized into an address bus, a data bus, a control bus, and the like. For ease of illustration, only one bold line is shown in FIG. 4 to represent the bus, but it does not mean that there is only one bus or one type of bus.

Optionally, in a specific implementation, if the memory 910, the processor 920, and the communication interface 930 are integrated on one chip, the memory 910, the processor 920, and the communication interface 930 may implement mutual communication through an internal interface.

According to an embodiment of the present application, a computer-readable storage medium storing a computer program is provided. When executed by a processor, the computer program implements the method described in any of above embodiments.

In the description of the specification, the description of the terms “one embodiment,” “some embodiments,” “an example,” “a specific example,” or “some examples” and the like means the specific features, structures, materials, or characteristics described in connection with the embodiment or example are included in at least one embodiment or example of the present application. Furthermore, the specific features, structures, materials, or characteristics described may be combined in any suitable manner in any one or more of the embodiments or examples. In addition, different embodiments or examples described in this specification and features of different embodiments or examples may be incorporated and combined by those skilled in the art without mutual contradiction.

In addition, the terms “first” and “second” are used for descriptive purposes only and are not to be construed as indicating or implying relative importance or implicitly indicating the number of indicated technical features. Thus, features defining “first” and “second” may explicitly or implicitly include at least one of the features. In the description of the present application, “a plurality of” means two or more, unless expressly limited otherwise.

Any process or method descriptions described in flowcharts or otherwise herein may be understood as representing modules, segments or portions of code that include one or more executable instructions for implementing the steps of a particular logic function or process. The scope of the preferred embodiments of the present application includes additional implementations where the functions may not be performed in the order shown or discussed, including according to the functions involved, in substantially simultaneous or in reverse order, which should be understood by those skilled in the art to which the embodiment of the present application belongs.

Logic and/or steps, which are represented in the flowcharts or otherwise described herein, for example, may be thought of as a sequencing listing of executable instructions for implementing logic functions, which may be embodied in any computer-readable medium, for use by or in connection with an instruction execution system, device, or apparatus (such as a computer-based system, a processor-included system, or other system that fetch instructions from an instruction execution system, device, or apparatus and execute the instructions). For the purposes of this specification, a “computer-readable medium” may be any device that may contain, store, communicate, propagate, or transport the program for use by or in connection with the instruction execution system, device, or apparatus. The computer readable medium of the embodiments of the present application may be a computer readable signal medium or a computer readable storage medium or any combination of the above. More specific examples (not a non-exhaustive list) of the computer-readable media include the following: electrical connections (electronic devices) having one or more wires, a portable computer disk cartridge (magnetic device), random access memory (RAM), read only memory (ROM), erasable programmable read only memory (EPROM or flash memory), optical fiber devices, and portable read only memory (CDROM). In addition, the computer-readable medium may even be paper or other suitable medium upon which the program may be printed, as it may be read, for example, by optical scanning of the paper or other medium, followed by editing, interpretation or, where appropriate, process otherwise to electronically obtain the program, which is then stored in a computer memory.

It should be understood various portions of the present application may be implemented by hardware, software, firmware, or a combination thereof. In the above embodiments, multiple steps or methods may be implemented in software or firmware stored in memory and executed by a suitable instruction execution system. For example, if implemented in hardware, as in another embodiment, they may be implemented using any one or a combination of the following techniques well known in the art: discrete logic circuits having a logic gate circuit for implementing logic functions on data signals, application specific integrated circuits with suitable combinational logic gate circuits, programmable gate arrays (PGA), field programmable gate arrays (FPGAs), and the like.

Those skilled in the art may understand that all or some of the steps carried in the methods in the foregoing embodiments may be implemented by a program instructing relevant hardware. The program may be stored in a computer-readable storage medium, and when executed, one of the steps of the method embodiment or a combination thereof is included.

In addition, each of the functional units in the embodiments of the present application may be integrated in one processing module, or each of the units may exist alone physically, or two or more units may be integrated in one module. The above-mentioned integrated module may be implemented in the form of hardware or in the form of software functional module. When the integrated module is implemented in the form of a software functional module and is sold or used as an independent product, the integrated module may also be stored in a computer-readable storage medium. The storage medium may be a read only memory, a magnetic disk, an optical disk, or the like.

The foregoing descriptions are merely specific embodiments of the present application, but not intended to limit the protection scope of the present application. Those skilled in the art may easily conceive of various changes or modifications within the technical scope disclosed herein, all these should be covered within the protection scope of the present application. Therefore, the protection scope of the present application should be subject to the protection scope of the claims.

What is claimed is:

1. A data analysis method, comprising:
acquiring historical behavior data of a user, wherein the historical behavior data comprises information on a historical time period and a historical behavior in the historical time period;
selecting first historical behavior data meeting a first preset condition from the historical behavior data of the user; and
determining a habit of the user based on the first historical behavior data meeting the first preset condition.

2. The data analysis method according to claim 1, wherein the first preset condition comprises:
an occurrence frequency of a first historical behavior during a first historical time period in a preset time period reaching a preset frequency threshold.

3. The data analysis method according to claim 2, wherein information on the first historical behavior comprises at least one of:
a label of the first historical behavior and a category of the first historical behavior.

4. The data analysis method according to claim 1, further comprising:
providing a recommendation for the user based on the determined habit of the user.

5. A data analysis device, comprising:
one or more processors; and
a memory for storing one or more programs, wherein
the one or more programs are executed by the one or more processors to enable the one or more processors to:
acquire historical behavior data of a user, wherein the historical behavior data comprises information on a historical time period and a historical behavior in the historical time period;
select first historical behavior data meeting a first preset condition from the historical behavior data of the user, and determine a habit of the user based on the first historical behavior data meeting the first preset condition.

6. The device according to claim 5, wherein the first preset condition comprises:
an occurrence frequency of a first historical behavior during a first historical time period in a preset time period reaching a preset frequency threshold.

7. The device according to claim 6, wherein information on the first historical behavior comprises at least one of:
a label of the first historical behavior and a category of the first historical behavior.

8. The device according to claim 5, wherein the one or more programs are executed by the one or more processors to enable the one or more processors to:
provide a recommendation for the user based on the determined habit of the user.

9. A non-transitory computer-readable storage medium, in which a computer program is stored, wherein the computer program, when executed by a processor, causes the processor to:
acquire historical behavior data of a user, wherein the historical behavior data comprises information on a historical time period and a historical behavior in the historical time period;
select first historical behavior data meeting a first preset condition from the historical behavior data of the user; and
determine a habit of the user based on the first historical behavior data meeting the first preset condition.

10. The non-transitory computer-readable storage medium according to claim 9, wherein the first preset condition comprises:
an occurrence frequency of a first historical behavior during a first historical time period in a preset time period reaching a preset frequency threshold.

11. The non-transitory computer-readable storage medium according to claim 9, wherein information on the first historical behavior comprises at least one of:
a label of the first historical behavior and a category of the first historical behavior.

12. The non-transitory computer-readable storage medium according to claim 9, wherein the computer program, when executed by a processor, causes the processor to:
provide a recommendation for the user based on the determined habit of the user.
